(19) United States
(12) Patent Application Publication
(10) Pub. No.: US 2012/0234040 A1
(43) Pub. Date: Sep. 20, 2012

(54) Bracelet

(76) Inventor: Daniel David Murphy, University Heights, OH (US)

(21) Appl. No.: 13/294,795

(22) Filed: Nov. 11, 2011

Related U.S. Application Data
(60) Provisional application No. 61/412,820, filed on Nov. 12, 2010.
(60) Provisional application No. 61/472,548, filed on Apr. 6, 2011.

(51) Int. Cl. A44C 5/00; G09G 5/00

(52) U.S. Cl. 63/1.11; 345/156

(57) ABSTRACT

Aspects include a wristband/bracelet with an emoticon display device (EDD) attached to it. The EDD will allow the user to change the emoticon that is being displayed. A first particular embodiment of the invention includes a wristband with the EDD attached to it, in which the EDD operates mechanically and the user pushes a button to change emoticons.

### CROSS-REFERENCE TO RELATED APPLICATION

This application claims the benefit of U.S. Provisional Application No. 61/412,820, filed on Nov. 12, 2010, and U.S. Provisional Application No. 61/472,548, filed on Apr. 6, 2011.

### BACKGROUND

In today's world, people have an increasing desire to express themselves and their emotions. Kids, in particular, are using an increasing number of outlets to do this. Social networks, text messaging, and multiple other resources are allowing them to communicate their thoughts to large groups of people with the simple push of a button. This movement shows no signs of slowing down either, with traditional social networks seeing unprecedented usage rates. New resources for people to communicate and express themselves more frequently are being developed.

### BRIEF SUMMARY OF THE INVENTION

Aspects of the invention include a wristband/bracelet with an emoticon display device (EDD) attached to it. The EDD allows the user to change the emoticon that is being displayed, which the user can do in accordance with how that user feels at that moment. For example, if the user is in a happy mood, he/she can display the emoticon for happiness. If his/her mood changes to sad, he/she can change the emoticon so that it signifies sadness. There will be several different emoticons for the user to choose from.

A first particular embodiment of the invention includes a wristband with an emoticon display device (EDD) attached thereto, in which the EDD allows a user to change an emoticon displayed using the EDD.

A second particular embodiment of the invention includes a method of changing an emoticon in a display using an emoticon display device (EDD), the method including operating the EDD to change an emoticon from a first display to a second display.

### BRIEF SUMMARY OF THE DRAWINGS

FIG. 1A shows a side view of a wristband/bracelet according to various embodiments of the invention.

FIG. 1B shows a plan view of a metal or magnetic member according to various embodiments of the invention.

FIG. 2 shows a blow-out three-dimensional perspective view of a wristband/bracelet according to various alternative embodiments of the invention.

### DETAILED DESCRIPTION

One such tool that people are using to show how they feel is emoticons. Another tool for expression is wristbands or bracelets. There are hundreds of different types of wristbands and bracelets, each offering a different message for the wearer to endorse. The described is a combination of both of these tools.

A wristband/bracelet with an emoticon display device (EDD) attached to it is disclosed according to various embodiments of the invention. The EDD will allow the user to change the emoticon that is being displayed, which they can do in accordance with how they are felling at that moment. For example, if the user is in a happy mood, they can display the emoticon for happiness. If their mood changes to sad, they can change the emoticon so that it signifies sadness. There can be several different emoticons for the user to choose from.

Embodiment 1 includes: A wristband with the EDD attached to it, in which the EDD operates mechanically and the user pushes a button to change emoticons.

A wristband according to embodiment 1 is also disclosed according to various embodiments, in which the EDD operates mechanically and the user turns a gear-like device to change emoticons.

A wristband according to embodiment 1 is also disclosed according to various embodiments, in which the EDD operates electronically and the user changes emoticons by using the electronic device.

A device according to embodiment 1 is also disclosed according to various embodiments, in which a wristband is not used, but the EDD is able to be attached or clipped onto a person or an object.

Another embodiment of the invention includes: A method of operating the wristband having the mechanical EDD in which a wristband is not used, but the EDD is able to be attached or clipped onto a person or an object.

Another embodiment of the invention includes: A method of operating the EDD having the electronically operable EDD in which a wristband is not used, but the EDD is able to be attached or clipped onto a person or an object.

Another embodiment of the invention includes: A method of operating the EDD according to embodiment 1, in which a wristband is not used, but instead a necklace in which the EDD operates mechanically and the user pushes a button to change emoticons.

Another embodiment of the invention includes: A method of operating a device with the EDD which operates mechanically and the user turns a gear-like device to change emoticons, in which a wristband is not used, but instead a necklace in which the EDD operates mechanically and the user turns a gear-like device to change emoticons.

Another embodiment of the invention includes: A method of operating the device having the electronically operable EDD, in which a wristband is not used, but instead a necklace in which the EDD operates electronically and the user changes emoticons by using the electronic device.

Another embodiment of the invention includes: A wristband according to embodiment 1, in which the EDD contains a compilation of movable parts that can form different faces (shapeable). This can be either mechanical or digital.

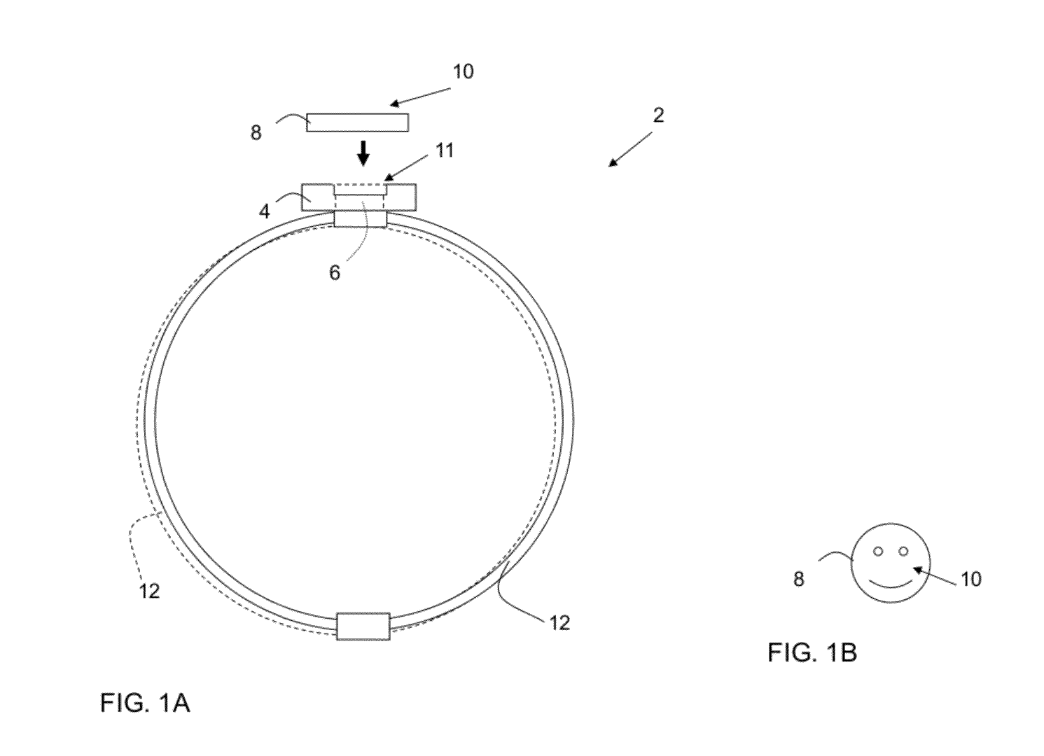

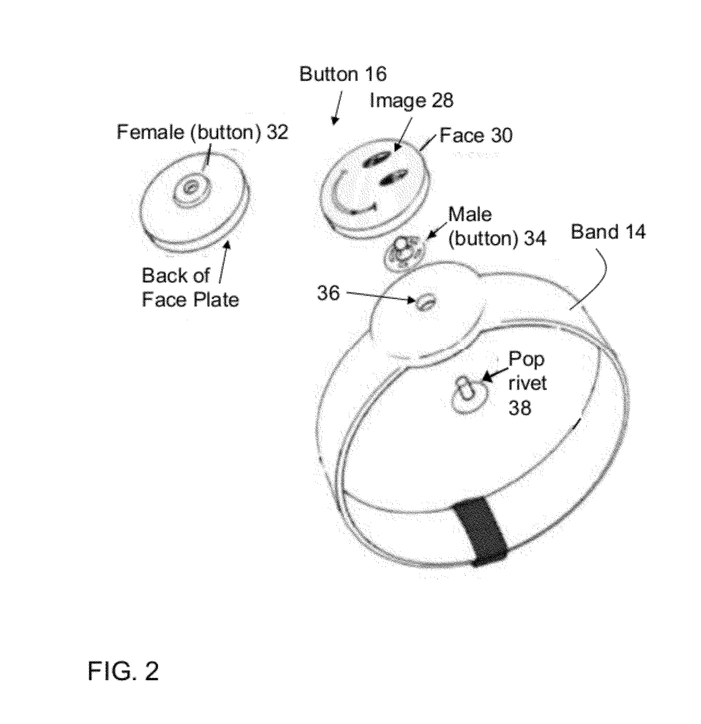

Another embodiment of the invention includes: A wristband in which the EDD contains magnetic parts. These pieces can be attracted to each other magnetically. The pieces may contain emoticons on them. They also may contain other information for display on the device. The attached FIG. 1A shows the different parts of a wristband 2, which include a docking station 4 with a magnet 6 (shown in phantom inside the docking station) or a piece of metal inside, a metal or magnetic piece 8 that contains an image 10 (e.g., an emoticon, obstructed in this view), and one or two wristbands 12 (second band 12 shown in phantom). In various embodiments, the magnetic version, can come in any of the previously mentioned forms above (necklace, wristband, detachable docking station, etc.). In some embodiments, the docking station 4 can include a finger groove 11 allowing a user to place a portion of his/her finger between the metal or magnetic piece 8 and the docking station 4 (e.g., to remove the metal or magnetic piece 8 from the magnet 6). FIG. 1B shows a plan view of the metal or magnetic piece 8 with the image 10. In various other embodiments, as shown in FIG. 2, instead of a magnetic device, a band 14 (or any other form that it may come in: necklace, etc) will have buttons 16 that can be taken on or off. The buttons 16 can have images 28 on them (such as emoticons, etc.), e.g., on a (plastic) face 30 of the button 16. Additionally, the button 16 can include a female part 32 and a complementary male part 34. The band 14 can be made of silicone in some embodiments. Further, the band 14 can include an opening 36 for receiving a pop-rivet button backing 38 which can secure the button 16 to the band 14. In other cases, in which buttons are not used, but the pieces with images on them may be taken on or off of the device (wristband, necklace, etc) in any way. It is understood that the embodiment in which the EDD contains magnetic parts (e.g., as shown in FIG. 1) can come in any of the previously mentioned forms (necklace, wristband, detachable docking station, etc.)

It is further understood that all of these embodiments described herein can contain information other than emoticons. Any type of image, including but not limited to sports teams, athletes, holidays, fundraising, business, school, politics, etc., may be displayed on the device.

In various other embodiments, the invention can include:

A wristband with an emoticon display device (EDD) attached thereto, in which the EDD allows a user to change an emoticon displayed using the EDD.

The wristband according to various embodiments, wherein the EDD operates mechanically and a user pushes a button to change the emoticon displayed using the EDD.

The wristband according to various embodiments, wherein the EDD operates mechanically and the user turns a gear device to change the emoticon.

The wristband according to various embodiments, wherein the EDD operates electronically and the user changes the emoticon displayed using an electronic device.

The wristband according to various embodiments, wherein the EDD contains a compilation of movable parts that can form different faces of the emoticons, and wherein the compilation of movable parts includes one of mechanical or digital movable parts.

A method of changing an emoticon in a display using an emoticon display device (EDD) is also disclosed according to various embodiments, the method including operating the EDD to change an emoticon from a first display to a second display.

The method according to various embodiments, wherein the EDD operates mechanically and a user pushes a button to change the emoticon in the EDD, and the EDD is configured to be attached or clipped onto a person or an object.

The method according to various embodiments, wherein the EDD operates mechanically and a user turns a gear device to change the emoticon, and the EDD is configured to be attached or clipped onto a person or an object.

The method according to various embodiments, wherein the EDD operates mechanically and a user turns a gear device to change the emoticon, and the EDD is configured to be attached or clipped onto a person or an object.

The method according to various embodiments, wherein the EDD is connected with a necklace, and wherein the EDD operates mechanically and a user pushes a button to change the emoticon.

The method according to various embodiments, wherein the EDD is connected with a necklace, and wherein the EDD operates mechanically and a user turns a gear device to change the emoticon.

The method according to various embodiments, wherein the EDD is connected with a necklace, and wherein the EDD operates electronically and a user changes the emoticons by using an electronic device.

The method according to various embodiments, wherein the EDD includes buttons that can be taken on or off of the EDD, and wherein the buttons have images on them forming the emoticons.

A wristband is also disclosed according to various embodiments, the wristband including: a display device; and a plurality of changeable magnetic parts configured to magnetically attach to the display device.

The wristband according to various embodiments, wherein each of the plurality of changeable magnetic parts includes an emoticon.

The wristband according to various embodiments, further comprising a band segment attached to the display device, wherein the band segment includes two bands.

I claim:

1-16. (canceled)

17. A wristband with an emoticon display device (EDD) attached thereto, in which the EDD allows a user to change an emoticon displayed using the EDD.

18. The wristband according to claim 17, wherein the EDD operates mechanically and a user pushes a button to change the emoticon displayed using the EDD.

19. The wristband according to claim 17, wherein the EDD operates mechanically and the user turns a gear device to change the emoticon.

20. The wristband according to claim 17, wherein the EDD operates electronically and the user changes the emoticon displayed using an electronic device.

21. The wristband according to claim 17, wherein the EDD contains a compilation of movable parts that can form different faces of the emoticons, and wherein the compilation of movable parts includes one of mechanical or digital movable parts.

22. A method of changing an emoticon in a display using an emoticon display device (EDD), the method including operating the EDD to change an emoticon from a first display to a second display.

23. The method of claim 22, wherein the EDD operates mechanically and a user pushes a button to change the emoticon in the EDD, and the EDD is configured to be attached or clipped onto a person or an object.

24. The method of claim 22, wherein the EDD operates mechanically and a user turns a gear device to change the emoticon, and the EDD is configured to be attached or clipped onto a person or an object.

25. The method of claim 22, wherein the EDD operates mechanically and a user turns a gear device to change the emoticon, and the EDD is configured to be attached or clipped onto a person or an object.

26. The method of claim 22, wherein the EDD is connected with a necklace, and wherein the EDD operates mechanically and a user pushes a button to change the emoticon.

27. The method of claim 22, wherein the EDD is connected with a necklace, and wherein the EDD operates mechanically and a user turns a gear device to change the emoticon.

28. The method of claim 22, wherein the EDD is connected with a necklace, and wherein the EDD operates electronically and a user changes the emoticons by using an electronic device.

29. The method of claim 22, wherein the EDD includes buttons that can be taken on or off of the EDD, and wherein the buttons have images on them forming the emoticons.

30. A wristband comprising:
a display device; and
a plurality of changeable magnetic parts configured to magnetically attach to the display device.

31. The wristband of claim 30, wherein each of the plurality of changeable magnetic parts includes an emoticon.

32. The wristband of claim 30, further comprising a band segment attached to the display device, wherein the band segment includes two bands.
